(19) United States
(12) Patent Application Publication
(10) Pub. No.: US 2010/0318740 A1
(43) Pub. Date: Dec. 16, 2010

(54) Method and System for Storing Real Time Values

(75) Inventor: Corradino Guerrasio, Genoa (IT)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/776,520

(22) Filed: May 10, 2010

(30) Foreign Application Priority Data
Jun. 12, 2009 (EP) 09 162 572.3

(51) Int. Cl. G06F 12/08

(52) U.S. Cl. 711/118; 711/E12.017

(57) ABSTRACT

A <<dynamic data cache module>> is inserted between the archiving subsystem (e.g. relational database writing API) and the tag data flow from the acquisition server. Then client data requests must be routed always through the <<dynamic data cache module>>. The dynamic data cache module>> is able to manage tag data that is not only coming from real-time acquisition (i.e. keeping the last n values of tag data in the cache) but also <<chunk>> of data in a different time span. For this usage, the cache will be size-limited and a last recently used (LRU) algorithm may be used to free up space when needed.

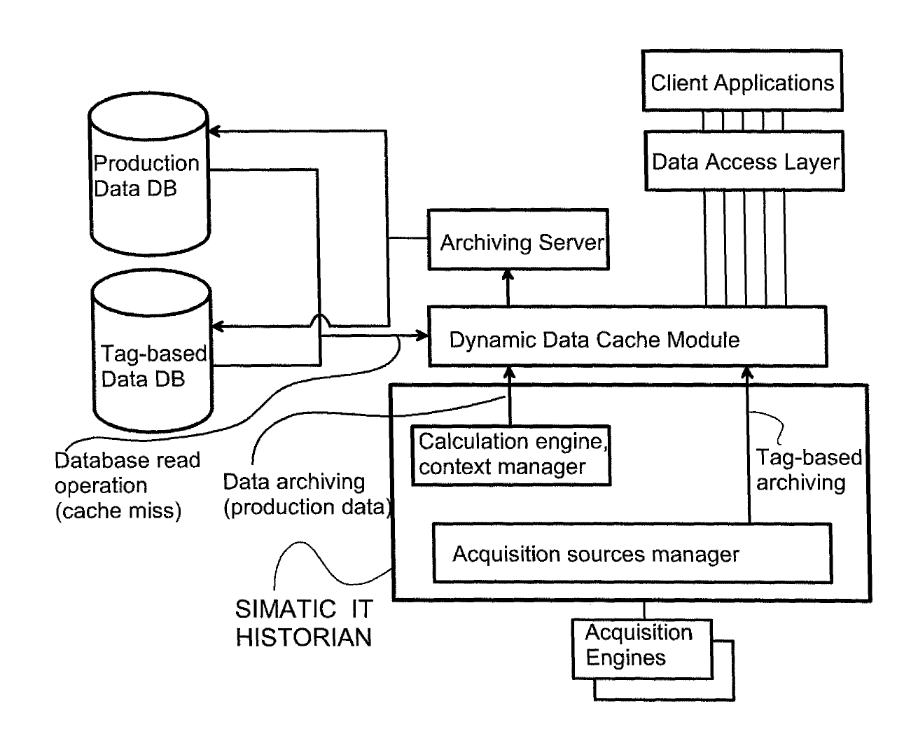

### CROSS-REFERENCE TO RELATED APPLICATION

This application claims the priority, under 35 U.S.C. §119, of European patent application EP 091 62 572, filed Jun. 12, 2009; the prior application is herewith incorporated by reference in its entirety.

### BACKGROUND OF THE INVENTION

### Field of the Invention

The present invention relates to a method and a system for storing real time values and providing them to a multiple number of client applications. More specifically, the method is implemented in a MES environment for storing real time values and providing them to a multiple number of client applications, where the real time values are originating via the MES environment from acquisition engines and/or from client applications. An archiving subsystem with at least one database is connected to the MES environment

In the world of process automation and process monitoring standard automation systems for controlling the widest conceivable variety of machines and plants are known in the art. Such technology covers in particular a broad range of products which are offered by the Siemens Corp. under its SIMATIC® product family with the field of manufacturing execution systems (MES). An extensive line of products for solving the technical tasks in question such as counting, measuring, positioning, motion control, closed-loop control and cam control enhance the performance capabilities of appropriate process controllers. A variety of configurations enable the implementation of flexible machine concepts.

The acronym SCADA stands for Supervisory Control And Data Acquisition. It generally refers to an industrial control system: a computer system monitoring and controlling a process. The process can be industrial, infrastructure or facility based as described below:

Industrial processes include those of manufacturing, production, power generation, fabrication, and refining, and may run in continuous, batch, repetitive, or discrete modes.

Infrastructure processes may be public or private, and include water treatment and distribution, wastewater collection and treatment, oil and gas pipelines, electrical power transmission and distribution, and large communication systems.

Facility processes occur both in public facilities and private ones, including buildings, airports, ships, and space stations. They monitor and control HVAC, access, and energy consumption.

A SCADA System usually consists of the following subsystems:
A Human-Machine Interface or HMI is the apparatus which presents process data to a human operator, and through this, the human operator, monitors and controls the process.
A supervisory (computer) system, gathering (acquiring) data on the process and sending commands (control) to the process.
Remote Terminal Units (RTUs) connecting to sensors in the process, converting sensor signals to digital data and sending digital data to the supervisory system.
Programmable Logic Controller (PLCs) used as field devices because they are more economical, versatile, flexible, and configurable than special-purpose RTUs.
Communication infrastructure connecting the supervisory system to the Remote Terminal Units.

There is, in several industries, considerable confusion over the differences between SCADA systems and Distributed control systems (DCS). Generally speaking, a SCADA system usually refers to a system that coordinates, but does not control processes in real time. The discussion on real-time control is muddied somewhat by newer telecommunications technology, enabling reliable, low latency, high speed communications over wide areas. Most differences between SCADA and DCS are culturally determined and can usually be ignored. As communication infrastructures with higher capacity become available, the difference between SCADA and DCS will fade.

In a generic Historian product, which is intended to acquire and store in a relational database real time tag values from the level 1 automation system (i.e., SCADA, but also OPC-enabled sources such as PLC, etc.), the load of the application running the acquisition and archiving subsystems will increase by remote clients or calculation subsystems which want to use the data being acquired as soon as it is available in the archive.

Moreover, remote clients that needs to read data asynchronously (e.g. reporting applications) will load the relational database, slowing down the archiving operations.

In a SCADA environment, there are only clients that display trends or elaborate data in real-time, which is not causing overload problems due to subscription to real-time feeds, which generally don't load the server much.

In MES environment, the problem is more evident, as there are more applications that rely on acquired data; complex calculation engines, OEE, SPC, reporting, data warehousing, etc.

U.S. Pat. No. 7,519,776 B2 describes a technique for managing memory items in a cache. An “age-lock” parameter is set to protect the newer memory items. When an incoming memory item (such as a history block header) is to be added to the cache, the amount of free space in the cache is checked. If there is insufficient free space for the incoming memory item, then space is freed up by removing memory items from the cache. No memory items protected by the age-lock parameter are removed. Of the older items, the selection for removal follows any of a number of well known cache management techniques, such as the “least recently used” algorithm. A “maximum size” parameter can be set for the cache. If the cache exceeds this maximum size, then free space is released and memory items are removed to decrease the cache size.

However in a SCADA environment, there is no need of caching due to real-time subscription of data. The clients subscribe to the server the tags for which they want the values and the server will push the values to all clients as soon as they are acquired. This is generally part of the application and solved by the implementation of the server.

In MES environment, most applications rely on relational database capabilities and queuing systems to optimize the overall system load. In MES environment, there are real-time clients that will subscribe data as in the SCADA scenario, but also client applications that need archived or delayed data as a calculation engine or data warehousing. In those scenarios, a careful design of the hardware and main system load is mandatory as the peak load of the system is not fully predictable and can bring the acquisition system to data loss.

Most of the prior art solutions as disclosed, for example, in

EP 1 471 441 B1;

U.S. Pat. No. 7,328,222 B2;

U.S. Pat. No. 7,40,1084 B1;

U.S. Pat. No. 7,401,187 B2 and

U.S. Pat. No. 7,421,437 B2

focus on the management of data in the cache and in particular to an algorithm to remove efficiently old data/unnecessary data from the cache.

The solution according to the above-mentioned U.S. Pat. No. 7,519,776 B2 is based on the “age” algorithm and not on a specific purpose/benefit of a particular cache implementation.

### SUMMARY OF THE INVENTION

It is accordingly an object of the invention to provide a method of storing real time values which overcomes the above-mentioned disadvantages of the heretofore-known devices and methods of this general type and which provides for an improved solution for storing real time values—especially tags—in a cache memory in MES environment for their specific clients.

With the foregoing and other objects in view there is provided, in accordance with the invention, a method in a manufacturing execution system (MES) environment, for storing real time values and providing the real time values to a multiple number of client applications. The real time values originate via the MES environment from acquisition engines and/or from client applications, and an archiving subsystem with at least one database is connected to the MES environment. The method comprises the following steps:

providing a dynamic data cache module, inserted in between the archiving subsystem and the MES environment, and receiving real time values with the dynamic data cache module;

storing the real time values in the dynamic data cache module subject to the following rules:
forwarding stored real time values to the archiving subsystem; and
permanently keeping a fixed number of last real time values ready for client requests to provide the real time values to the requests of specific client applications.

In other words, the advantages of the present invention are the usage of the “write through” algorithm to write real-time values in the cache and make them available to clients before actually having written them in the database. This will reduce load on the SQL database, as having the data—that is, the tag values—in the cache.

In accordance with an added feature of the invention, the real time values are additionally stored in the dynamic data cache module for a configurable amount of time.

In accordance with an additional feature of the invention, the fixed number of the last values for keeping at ready are derived from a maximum amount of available memory size.

In accordance with another feature of the invention, individual real time values are marked as <<cache disabled>> in order to free memory space in the dynamic data cache module.

In accordance with a further feature of the invention, the dynamic data cache module is controlled with an archiving server.

With the above and other objects in view there is also provided, in accordance with a concomitant feature of the invention, a corresponding system in a manufacturing execution system (MES) environment, that is configured with the necessary means for carrying out the above-summarized method.

Other features which are considered as characteristic for the invention are set forth in the appended claims.

Although the invention is illustrated and described herein as embodied in a method and a system for storing real time values, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of a specific embodiment when read in connection with the accompanying drawing.

### BRIEF DESCRIPTION OF THE DRAWING

The FIGURE is an overview diagram of the components in a MES environment involved in carrying out the method according the invention.

### DETAILED DESCRIPTION OF THE INVENTION

Referring now to the sole FIGURE of the drawing in detail, there is shown an historian system denoted by <<SIMATIC IT HISTORIAN>> and outside a production database and a tag-based database. The historian system denoted by <<SIMATIC IT HISTORIAN>> and all MES client applications is also called <<MES environment>>. Data requests from client applications via a data access layer are either transferred directly to the <<dynamic data cache module>> or via the before-mentioned databases. The <<dynamic data cache module>> is fed from the historian system and/or the data access layer. Data is then transferred to the <<archiving server>> or directly to the relational database(s). The production database and a tag-based database are in the context of this patent document summarized as archiving subsystem.

The load of the system will be reduced and avoids data loss in a MES scenario with adding a <<dynamic data cache module>>, which is a middleware software module, which takes care to keep dynamically in memory the tag values from the <<MES environment>> (see FIGURE) and provide them to client applications when they ask for them. A <<dynamic data cache module>> will sacrifice system memory by keeping in memory a configurable maximum amount of tag values for clients. This <<dynamic data cache module>> receives from the acquisition engines real-time tags and keeps them in memory for a configurable amount of time or alternatively to a maximum amount of system memory.

The <<dynamic data cache module>> is inserted between the archiving subsystem (e.g. relational database writing API) and the tag data flow from the acquisition server, i.e. the historian system. Then client data requests must always be routed through the <<dynamic data cache module>>.

During normal working conditions, the <<dynamic data cache module>> will forward tag data to the archiving subsystem, keeping always the last n values in memory, ready for client requests. Possible changes to values from the connected clients will be applied to the archiving subsystem with a so called <<write-through mechanism>>, keeping the cache up-to-date.

Further a “read-ahead” mechanism is implemented for historical tag requests, if the tag values requests are not being acquired in real-time or out of the cache size. This improves performance and system load as it is more efficient to fetch bigger and continuous part of data out of a relational database than asking a bigger number of smaller parts of data.

Moreover, during a configuration phase, a tag may be flagged as <<cache disabled>> to filter out known not frequently used tags and leave space in memory for the relevant ones only. All other tags will be dynamically added or removed from cache depending on client's requests.

The usage of the <<write-through mechanism>> or also denoted by <<write-through algorithm>> to write real-time values in the cache and make them available to clients before actually having written them in the database reduces load on the SQL database, as having data in the cache, clients do not need to access it from the database. Moreover the SQL writing application can buffer data and write it to the database with bigger or bulk queries, improving efficiency and reducing again the load on the database. This latter part is generally not feasible as clients accessing directly the database want to read the data as soon as it is available, so buffering before writing is not so good. Using the cache, this problem is solved and buffering algorithm can be used. Clients will also benefit of improved response time, as data will be read from cache memory and not from database.

Cache configuration consists in which tags to keep in cache and which not. This can be very helpful when tuning the system in a real installation, as only relevant data will be kept in memory. Also the maximum number of values for each tag can be configured.

Usage of cache for two kinds of tag data:

real-time feeds (the main purpose)

“historical data access”.

Generally in historian applications, historical tag data access is not included in the time span managed by the cache and will always go directly to the database without affecting the cache.

Using a dynamic cache server makes it possible to reserve some space for historical queries optimization. By applying a <<read ahead>> algorithm and then keep this fetched historical tag data in the cache to foresee subsequent client requests and use in a more efficient way the underlying database.

In other words, the cache will be able to manage tag data that is not only coming from real-time acquisition (i.e. keeping the last n values of tag data in the cache) but also <<chunk>> of data in a different time span. For this usage, the cache will be size limited and last recently used (LRU) algorithm may be used to free space when needed.

The invention and its advantages may be summarized as follows:
A. Basically the idea is to have a tag values cache in between the real-time acquisition system and the clients with all features mentioned above, using well-known algorithms and techniques.
B. Instant data availability for cached tag values, at least for the amount covered by the cache size. This is valid also if the number of clients is very high.
C. Smaller load on underlying database subsystem, which will be more available for archiving: this will improve the product capabilities (i.e. maximum sustainable archiving rate).
D. Write through algorithm: data will be available to clients before it will be actually written to database.
E. Smaller overall system load.

On the fact having real-time cache for tag data between an historian system (or the historian part of a SCADA), acquiring tags to be stored in a database, and the clients/interfaces accessing them a possible implementation may be an application (executable) which operates as a “cache server”: all tag data to be written will go through it and then to the database; and all clients/interfaces accessing data will go through it before asking the database server.

So if from one side this cache server application will be connected to both historian server and clients, it is not really needed for them to interoperate, as the cache has the only purpose to improve response speed for clients and reduce load on the database server.

1. In a manufacturing execution system (MES) environment, a method of storing real time values and providing the real time values to a multiple number of client applications, where the real time values originate via the MES environment from acquisition engines and/or from client applications, and where an archiving subsystem with at least one database is connected to the MES environment, the method which comprises:
providing a dynamic data cache module, inserted in between the archiving subsystem and the MES environment, and receiving real time values with the dynamic data cache module;
storing the real time values in the dynamic data cache module subject to the following rules:
forwarding stored real time values to the archiving subsystem; and
permanently keeping a fixed number of last real time values ready for client requests to provide the real time values to the requests of specific client applications.

2. The method according to claim 1, which comprises additionally storing the real time values in the dynamic data cache module for a configurable amount of time.

3. The method according to claim 1, which comprises deriving the fixed number of the last values for keeping at ready from a maximum amount of available memory size.

4. The method according to claim 1, which comprises marking individual real time values as <<cache disabled>> in order to free memory space in the dynamic data cache module.

5. The method according to claim 1, which comprises controlling the dynamic data cache module with an archiving server.

6. The method according to claim 1, wherein the real time values are tags.

7. In a manufacturing execution system (MES) environment, a system comprising devices configured to carry out the method according to claim 1.
